(19) United States
(12) Patent Application Publication
(10) Pub. No.: US 2018/0060833 A1
(43) Pub. Date: Mar. 1, 2018

(54) METHOD AND SYSTEM FOR THE MAINTENANCE OF VEHICLES, FACILITY IMPLEMENTING SUCH A METHOD AND SYSTEM

(71) Applicant: BLUECARSHARING, Vaucresson (FR)

(72) Inventors: Brice BELVEYRE, Paris (FR); Guillaume HUGLA, Paris (FR)

(21) Appl. No.: 15/558,294

(22) PCT Filed: Mar. 7, 2016
(86) PCT No.: PCT/EP2016/054793

§ 371 Date: Sep. 14, 2017

(30) Foreign Application Priority Data
Mar. 18, 2015 (FR) 1552230

(51) Int. Cl. G06Q 10/00; G06Q 30/06

(52) U.S. Cl. CPC G06Q 10/20; G06Q 30/0645

(57) ABSTRACT

A method is provided for the maintenance of vehicles offered for shared use over a plurality of sites, the method including at least one iteration of the following steps:
reporting at least one data, relating to a condition of the vehicle or a component of the vehicle;
determining, as a function of the at least one status data, at least one vehicle status parameter, associated with the vehicle;
   the method also including at least one iteration of a phase, called work phase, including the following steps:
selecting at least one site, as a function of the vehicle status parameters at least of the vehicles present on the at least one site;
carrying out a maintenance operation on at least one vehicle at the selected site.

The present invention relates to a method for the maintenance of vehicles offered for shared use over a plurality of sites, in particular within the framework of an installation for the automated rental of electric vehicles over a plurality of sites. It also relates to a system implementing such a method and an installation for the automated rental of vehicles over a plurality of sites implementing such a method and/or such a system.

The field of the invention is the field of the maintenance of a fleet of vehicles offered for shared use over a plurality of sites distributed over an area.

### PRIOR ART

Shared use of a plurality of vehicles, for example within the framework of automated vehicle rental, is a field experiencing rapid growth. In population centres where it is desirable to reduce the number of vehicles present in the area, automated vehicle rental systems are being established, such as for example for electric cars or bicycles.

These installations comprise sites for the collection/return of vehicles, distributed over a geographical area, making it possible to collect a vehicle from one site, called departure site, and to return the same vehicle to a site, called arrival site. In most cases, the departure site and the arrival site are different, which makes shared use of the vehicle flexible for the user.

However, this flexibility of use of the vehicles is accompanied by a difficulty for the maintenance of the vehicles, which are constantly changing sites. In fact, it is difficult, time-consuming and very expensive in human resources, on the one hand to identify the vehicles that require a maintenance operation, and on the other hand to carry out the maintenance operations. In addition, carrying out maintenance operations on the vehicles requiring maintenance is difficult to coordinate and involves a not insignificant period of immobilization of the vehicles while awaiting maintenance.

A purpose of the present invention is o overcome the abovementioned drawbacks.

A further purpose of the invention is to propose a method and a system for the maintenance of vehicles offered for shared use over a plurality of sites distributed over an area allowing the maintenance of the vehicles to be facilitated.

A further purpose of the invention is to propose a method and a system for the maintenance of vehicles offered for shared use over a plurality of sites distributed over an area, allowing the cost of the maintenance of the vehicles to be reduced.

Finally, a further purpose of the invention is to propose a method and a system for the maintenance of vehicles offered for shared use over a plurality of sites distributed over an area allowing the immobilization time of the vehicles to be reduced.

### DISCLOSURE OF THE INVENTION

The invention proposes to achieve at least one of the aforementioned purposes by a method for the maintenance of vehicles offered for shared use over a plurality of sites, in particular within the framework of an installation for the automated rental of electric vehicles over a plurality of sites, the method comprising for each vehicle, at least one iteration of a phase, called reporting phase, comprising the following steps:
reporting at least one data, called status data, relating to a status of said vehicle or a component of said vehicle;
determining, as a function of said at least one status data, at least one parameter, called vehicle status parameter, associated with said vehicle or said component of said vehicle;
   said method also comprising at least one iteration of a phase, called work phase, comprising the following steps:
selecting at least one site, as a function of the vehicle status parameters at least of the vehicles present at said at least one site;
carrying out a maintenance operation on at least one vehicle at said selected site.

Thus, the method according to the invention makes it possible to determine the maintenance requirements of a vehicle as a function of reported data, for example by a user using the vehicle and/or an operator working on the vehicle, without the need to move said vehicle to a maintenance site. As a result, the identification of the vehicles that require maintenance is carried out more simply, more cheaply in terms of human resources, and in a less time-consuming fashion.

In addition, the method according to the invention proposes to carry out the maintenance of the vehicles per site, as a function of the maintenance requirements for the vehicles present at each site, which makes it possible to carry out maintenance more quickly and more cheaply in terms of human resources and to reduce the immobilization time of the vehicles while awaiting maintenance.

According to a first embodiment, the selection step can comprise selecting, from among all the sites, the site having the largest number of vehicles for which the vehicle status parameter verifies a predetermined relationship, in particular shows a degraded status beyond a predetermined status.

In this case, a maintenance team working at this site allows the greatest number of vehicles to be dealt with, which makes it possible on the one hand to keep these vehicles available for use and thus to reduce the immobilization time of the vehicles while awaiting maintenance, and on the other hand to optimize the use of the human resources and the working time for the maintenance per number of vehicles.

According to another embodiment, the selection step can comprise selecting, from among all the sites, the site having the vehicle for which the vehicle status parameter shows a status that is the most degraded status among all the sites.

This embodiment makes it possible to work on the vehicle that requires the work most urgently and to avoid said vehicle being immobilized and no longer able to be used by the users. Similarly, this makes it possible to work on a vehicle urgently and to avoid using a vehicle the use of which may present a risk for the user.

The work phase can also comprise a step for each site of determining a parameter, called site status parameter, by a predetermined relationship taking account of the status parameter(s) of the vehicle(s) present at said site, the step of selecting a site being carried out as a function of said status parameter of the site.

For example, such a status parameter of the site can be determined by addition, multiplication, etc. of the values of the vehicle status parameters of the vehicles present at said site.

For at least one site, determining the site status parameter can also take account of other parameters such as for example an average presence time of a vehicle at said site, a total number of vehicles present at said site, etc.

In this case, the selection step can comprise selecting, from all the sites, at least one site for which the site status parameter verifies a predetermined relationship, in particular shows a degraded status beyond a predetermined status.

For example, the selection step can comprise selecting each site the value of the status parameter of which is greater than or equal to a predetermined threshold, called work threshold, that is optionally adjustable.

Alternatively, the selection step can comprise selecting, from all the sites, the site for which the site status parameter shows a status that is the most degraded among all the sites, for example the site having the highest value for the site status parameter among all the sites.

The selection step can comprise selecting, from among all the sites, a predetermined number “n” for example n=10, the statuses of which are the most degraded, or are degraded beyond a predetermined threshold, as a function of:
the vehicle status parameters of the vehicles located at each of said sites; or
site status parameters of each of said sites.

Advantageously, the method according to the invention can also comprise displaying on a geographical map the location of said selected sites, as a function of geolocation data of each site. Thus it is possible to visually identify a geographical area comprising the largest number of sites requiring maintenance, and to carry out work that can cover the largest possible number of sites.

Alternatively, the work phase can comprise, before the selection step, a step of determining a geographical area, called the most degraded, of a predetermined size, optionally adjustable, comprising the sites the statuses of which are the most degraded, or the statuses of which are degraded beyond a predetermined threshold, as a function of:
the vehicle status parameters of the vehicles located at each of said sites; or
the site status parameters of each of said sites;
   the selection step comprising a selection of one or more, in particular all, the sites located in said geographical area, optionally after displaying on a geographical map the location of said sites situated in said geographical area.

For example, the predetermined size of the geographical area can be a radius of 500 m.

Determining the geographical area that is the most degraded can comprise an iteration of the following steps for each site:
identifying all the sites located in the geographical area associated with said site, for example located at less than 500 m from said site, as a function of geolocation data of said sites;
determining, for said geographical area associated with said site, an area status parameter according to a predetermined algorithm, for example by addition, as a function of:
   vehicle status parameters of the vehicles located at the sites located in said geographical area; or
   site status parameters of the sites located in said geographical area.

Then, the geographical area having an overall status parameter value that is the most degraded is selected from among all the geographical areas.

Advantageously, for at least one vehicle, at least one reporting step can be carried out from inside said vehicle or at said vehicle, by a user of said vehicle or by an operator working on said vehicle.

In fact, it is for example possible for a user using the vehicle to report a status data at the start and/or at the end of use of the vehicle. Alternatively, or in addition, such a report of a status data can be carried out by an operator working on the vehicle, for example with a view to carrying out re-balancing between sites.

Advantageously, for at least one vehicle, at least one step of reporting a status data can be carried out through a user interface in said vehicle.

Alternatively or in addition, for at least one vehicle, at least one step of reporting a status data can be carried out through a user interface on:
a terminal located at a site at which said vehicle is located; or
a portable communication device.

At least one user interface can comprise a display screen, touch-operated or not, through which the user or the operator inputs one or more status data.

The input of a status data can be carried out either by free input or by selecting one suggestion from among at least two suggestions, in particular displayed on a screen.

The step of reporting a status data can be mandatory in order to use the vehicle. In this case, the user cannot begin to use the vehicle, or terminate a use of the vehicle, until the step of reporting the one or more status data has been carried out.

Advantageously, for at least one vehicle, the method according to the invention can comprise a step of weighting at least one status data by at least one weighting coefficient the value of which is a function of:
the originator of the report of said status data: for example a status data reported by an operator can be weighted differently, and in particular can be given greater importance, compared with a status data reported by a user;
a value of said status data: for example a status data reporting an extreme level of degradation can be weighted differently, and in particular can be given greater importance, compared with a status data reporting another level of degradation;
a duration separating the report of said status data from a previous report;
   the vehicle status parameter being determined as a function of said weighted status data.

Such a weighting makes it possible to obtain a more accurate and more objective view of the status of the vehicle and thus to carry out more appropriate maintenance.

This weighting can be carried out by multiplying the value of at least one of the status data by one or more predetermined multiplication coefficients.

More generally, at least one status parameter of at least one vehicle can be determined by use of a predetermined relationship or algorithm taking account of:

the originator of the report of said status data;
a value of said status data; and
a duration separating the report of said status data from a previous report.

The method according to the invention can also comprise a step of zero setting, and more generally a step of reinitialization, of at least one vehicle status parameter following sending, by an operator, of a data reporting:
the end of a maintenance operation on said vehicle; or
a statement, by the operator, of a non-degraded status of said vehicle or a component of said vehicle.

Thus, when an operator carries out a maintenance operation, the status parameter is reinitialized. In addition, when an operator states that the report previously issued by a user is incorrect, the status parameter is also reinitialized.

According to a particularly advantageous application, the reporting step can realizes the reporting of a status data relating to a general cleanliness status of the vehicle, the vehicle status parameter showing said cleanliness status, and the maintenance operation carried out comprises a vehicle cleaning operation.

In this case, the report step can be carried out by selecting, on a user interface inside the vehicle, one suggestion among a plurality of suggestions relating to the cleanliness of the vehicle, such as for example suggestions of the type “very clean”, “clean”, “acceptable”, “dirty” and “very dirty”.

Each suggestion can be displayed by a colour and/or by an emoticon and/or by a text and/or by a number/figure.

Similarly, each suggestion can be selected by pressing a button, mechanical or touch-operated, comprising an indication in the form of a colour and/or an emoticon and/or a text and/or a number/figure.

Alternatively, or in addition, the report step can issue a report of a status data relating to a functional status of a component of the vehicle, such as a screen, radio, handbrake, rear-view mirror, engine, seat, GPS, etc. of the vehicle, an electricity plug, etc.

In this case, the report step can comprise the following steps:
selecting the component to which the report relates, and
inputting a value relating to the functional status of said component, on a user interface inside the vehicle, for example by selecting one suggestion from among a plurality of suggestions.

Each suggestion can be displayed by a colour and/or by an emoticon and/or by a text and/or by a number/figure.

Similarly, each suggestion can be selected by pressing a button, mechanical or touch-operated, comprising an indication in the form of a colour and/or an emoticon and/or a text and/or a number/figure.

According to an embodiment, a vehicle can be associated with several vehicle status parameters, each of the vehicle status parameters relating to a component of said vehicle:
the report step comprising reporting a status data relating to one or more components of the vehicle;
the work phase being carried out independently for each status parameter of the vehicle.

For example, for a given vehicle:
a vehicle status parameter can be associated with the brakes of the vehicle;
another vehicle status parameter can be associated with the radio of the vehicle;
etc.

As the maintenance of these components requires very different skills/operations, the work phase can be carried out independently for each component.

Alternatively, for at least two components of the vehicle, the work phase can be aggregated and carried out by a single operator.

Advantageously, the method according to the invention can comprise a classification of the maintenance operations into one category among several predetermined categories, according to the nature of the maintenance operation and/or the component in question. One or more operators can be associated with each category, for example as a function of the skills of the operators. The work phase can then be carried out independently for each category.

When the work phase is carried out independently for each component or each category, the step of carrying out a maintenance operation can comprise a step of determining the operator(s) associated with the maintenance of said component or said category, and a selection of at least one operator among said operators.

According to another embodiment, a single vehicle status parameter can be associated with a vehicle, determined as a function of status data relating to several components of the vehicle, the report step comprising reporting a status data relating to one or more components of the vehicle.

For example, for a given vehicle the single vehicle status parameter can be determined as a function of status data relating to:
a status of a radio of the vehicle;
a status of a tyre of the vehicle;
etc.

In this latter embodiment, determining the vehicle status parameter can comprise a weighting of at least one status data, as a function of the nature of the component to which said status data relates, the single vehicle status parameter being determined as a function of said weighted status data.

For example, the weighting can be carried out as a function of the importance of the component to the functioning of the vehicle. Thus, as a tyre is more important than a radio, the weighting applied can give more importance to the status data relating to the tyre, compared to the status data relating to the radio.

This weighting can be carried out by multiplying the value of at least one of the status data by one or more predetermined multiplication coefficients, optionally adjustable, and associated with each component of the vehicle.

More generally, at least one status parameter of at least one vehicle can be determined by use of a predetermined relationship or algorithm taking account of the status data relating to different components of the vehicle, optionally with a weighting of at least one of said status data.

The step of triggering a maintenance operation can comprise sending, for example through a communication network to a device carried by an operator, data relating to said site and/or to said at least one vehicle, and optionally to said maintenance to be carried out, to at least one operator, optionally selected beforehand from several operators, as described above.

According to another aspect of the same invention, a system for the maintenance of vehicles offered for shared use over a plurality of sites is proposed, in particular within the framework of an installation for the automated rental of electric vehicles over a plurality of sites, said system comprising means configured in order to implement all the steps of the method according to the invention.

Such a system can comprise:
at least one interface for reporting a status data from inside each vehicle or from each site or through a portable communication device, configured in order to send to a remote server, through a communications network, a data relating to a status of the vehicle or a functional status of a component of the vehicle;
at least one server, placed at a central site, and configured in order to:
   receive status data for at least one, in particular each, vehicle;
   determine at least one parameter, called vehicle status parameter, associated with each vehicle;
   select at least one site from the plurality of sites as a function of said at least one status parameter; and
   trigger a maintenance operation on at least one vehicle at said at least one selected site, for example by sending to at least one operator data relating to said site and to said at least one vehicle, and optionally to said maintenance to be carried out.

According to another aspect of the same invention, an installation for the automated rental of vehicles, in particular electric vehicles over a plurality of sites, is proposed, said installation comprising:
a system according to the invention; or
means configured for implementing all the steps of the method according to the invention.

### DESCRIPTION OF THE FIGURES AND EMBODIMENTS

Other advantages and characteristics will become apparent on examination of the detailed description of embodiments which are in no way limitative, and from the attached drawings, in which:

FIG. 1 is a diagrammatic representation of an installation for the automated rental of vehicles implementing the method according to the invention;

FIG. 2 is a diagrammatic representation in the form of a flowchart of an example of a maintenance method according to the invention; and

FIG. 3 is a diagrammatic representation of an example user interface for reporting a status data relating to the cleanliness of a vehicle.

It is well understood that the embodiments which will be described hereinafter are in no way limitative. It is possible in particular to imagine variants of the invention comprising only a selection of features described hereinafter, in isolation from the other features described, if this selection of features is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

In particular, all the variants and all the embodiments described can be combined together if there is no objection to this combination on technical grounds.

The examples described below relate to automated rental of electric cars over several rental sites. Of course, the invention is not limited to use in such an installation.

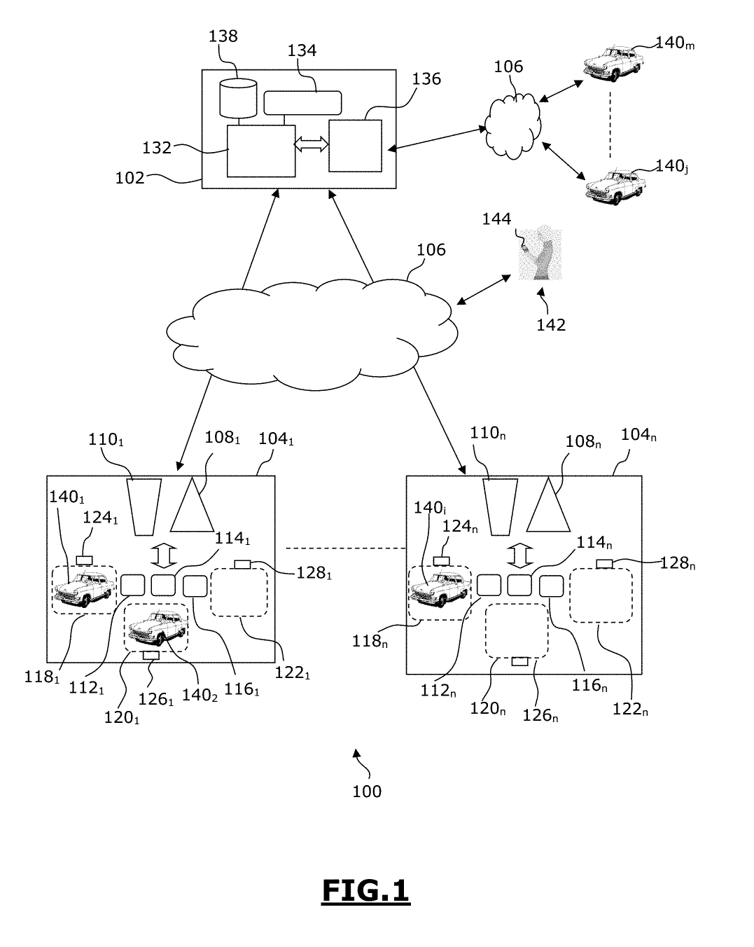

FIG. 1 is a diagrammatic representation of an installation for the automated rental of electric vehicles in which the invention can be implemented.

The installation 100 shown in FIG. 1 comprises a central site 102 connected to several sites—or stations—104₁-104n, called rental sites, through a wireless communication network 106, for example GPRS, or a wired network, for example of the DSL or LAN type. Preferably, each site 104 is linked to the central site 102 via two separate networks, which allows a continuous connection even if one of the networks fails.

Each rental site 104 comprises a rental terminal 110 for renting a vehicle and several charging terminals 112-116, each charging terminal being provided in order to charge a vehicle equipped with an electric battery at a parking space, namely the parking spaces 118-122.

Some rental sites 104 also comprise a subscription terminal 108 for registering a new subscriber.

Each parking space 118-122 of a rental site 104 comprises a presence detection module 124-128, namely weighing means, a camera and/or an infrared sensor and/or a detector of an electrical connection with a vehicle and/or a radar, connected to the rental terminal 110 of the rental site 104.

The central site 102 can be connected directly to each of the terminals of a rental site 104 through the network 106 or only to the subscription terminal and/or the rental terminal and/or to the charging terminals 112-116.

At least two terminals of a rental site are connected together through a wired connection (not shown).

The central site 102 comprises a central management server 132, a synthesis module 134 and a communication module 136, called a central module.

The central site 102 also comprises a database 138 in which data are stored relating to each of the sites 104 and data relating to each of the vehicles 140₁-140ₘ, offered for rental within the framework of the installation 100.

The central site 102 is in communication with each of the electric vehicles 140₁-140ₘ, awaiting rental or currently rented, via a central communication module 136 and a communication box (not shown), called a vehicle communication box, arranged in each of the vehicles 140, through the wireless communication network 106. Of course, the vehicles that are currently rented and are elsewhere than on a rental site can communicate with the central site through a communication network different from the network 106 used by the rental sites.

The installation 100 also comprises one or more operators 142 carrying a portable communication device 144 and carrying out maintenance on one or more vehicles present on the rental sites 104.

The database 138 stores:
in association with the identifier of each vehicle 140 offered for rental, at least one vehicle status parameter;
in association with the identifier of a rental site 104, a site status parameter.

A user or an operator is able to interact with the installation 100, in particular with the remote site 102, and also more particularly with the server 132, via a user interface accessible from:
a terminal at a rental station, and in particular the rental terminal 110;
each vehicle 140; and/or
an application run for example on a portable user device of the smartphone type.

Thus, a user or an operator can report one or more status data to said central site 102, through said user interface.

The status data reported by the user and/or by the operator are used in order to determine and update the value of one or more vehicle status parameters associated with said vehicle 140.

For each site 104, the value of a site status parameter is determined and updated as a function of the values of the status parameter(s) of each vehicle 140 located at said site 104.

Thus, for a given vehicle 140, the user can report:
a status data relating to the cleanliness of the vehicle 140; and/or
at least one status data relating to the functioning of at least one component of the vehicle 140, such as a radio, tyre, engine, etc. of said vehicle.

Each of these status data can for example be presented in the form of a figure or a note.

Status data relating to a vehicle can be used in order to determine a single vehicle status parameter, regardless of the vehicle component to which they relate.

Alternatively, each of the status data relating to a specific component of the vehicle or to the cleanliness of the vehicle can be used individually for determining and updating a vehicle status parameter associated with said component or said cleanliness of the vehicle independently of the status data relating to the other components of the vehicle.

As a function of the status parameter(s) of the vehicles 140 present at a site 104, a site status parameter is determined for said site. As a function of the status parameters of each of the sites 104, at least one site is selected in order to carry out maintenance on at least one vehicle 140 located at said site. The identification data of the site and of the vehicle(s) to which the maintenance relates are sent to the communication device 144 of the operator 142, in order to trigger a maintenance operation.

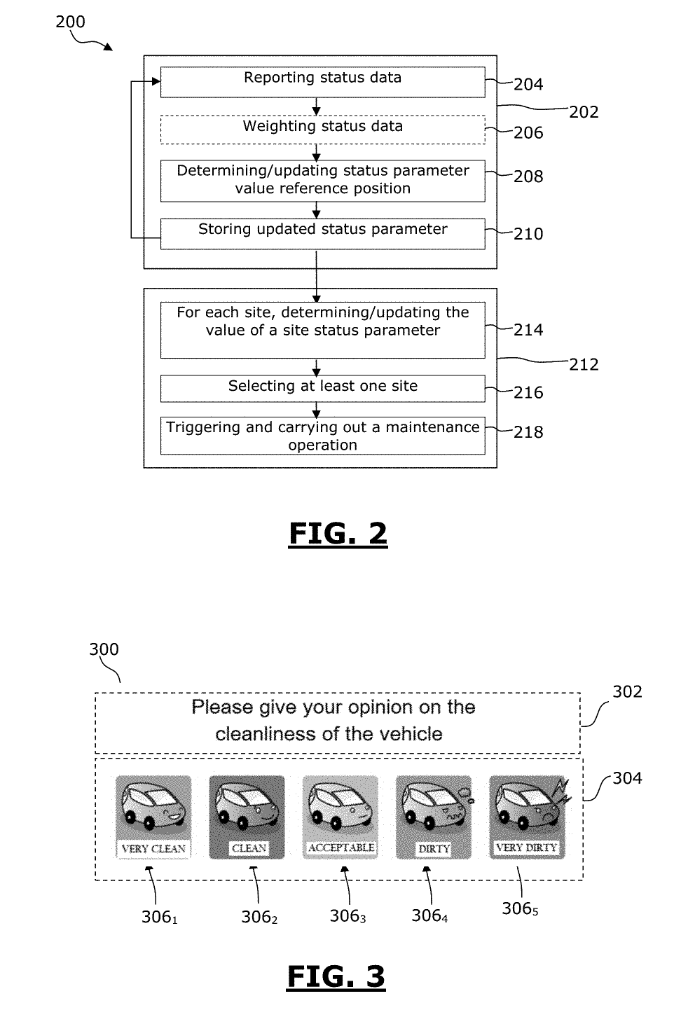

An example of a method for the maintenance of vehicles that can be implemented within the framework of the installation 100 in FIG. 1 will now be described with reference to FIGS. 2 and 3. In order to simplify the description, it will be assumed that the maintenance relates to cleaning the vehicle only. Of course, the invention is not limited to cleaning the vehicles and can relate to all the maintenance tasks that can be carried out on a vehicle, in particular an electric vehicle.

FIG. 2 is a diagrammatic representation in the form of a flowchart of an example of a maintenance method according to the invention.

The method 200 shown in FIG. 2 comprises at least one iteration of a phase 202, called reporting phase.

This phase 202 comprises a step 204 making it possible for an operator or a user to report a data relating to the cleanliness status of a vehicle. This step 202 can for example comprise:
selecting, through a user interface for example inside the vehicle, one suggestion from among a plurality of suggestions relating to the cleanliness status of the vehicle; and
sending said suggestion to a remote site, for example the site 102, in association with an identification data of the vehicle, and optionally an identification data of the person originating this report and/or a timestamp relating to said report.

Within the framework of cleaning the vehicles, each status data can for example correspond to a figure between 1 and 10, selected by the user, the figure “1” corresponding to a “very clean” status and the figure “10” corresponding to a “very dirty” status.

During an optional step 206, the status data reported can be weighted upward or downward as a function of:
the originator of the report of said status: for example a status data reported by an operator can be weighted so as to be given greater importance, compared with a status data reported by a user;
a value of said status data: for example a status reporting an extreme level of cleanliness/dirtiness can be weighted so as to be given greater importance, compared with a status data reporting another level of cleanliness/dirtiness;
a duration separating the report of said status data from a previous report: for example if the reports of the status data are frequent, then the status data can be weighted so as to be given greater importance, and vice versa.

The weighting can be carried out by multiplying the status value by one of the predetermined coefficient(s), for example:
multiplication by a coefficient 3 if the originator of the report is an operator;
multiplication by a coefficient of 1.5 if the status data reported=1 or 10;
multiplication by a coefficient 2 if the time elapsed since the report is greater than or equal to three weeks;
etc.

During a step 208, the value of a vehicle status parameter associated with said vehicle is updated, for example by the server or by the module 134, as a function of the optionally weighted status data. This updating can be carried out as a function of a predetermined relationship and optionally can be adjusted. By way of a non-limitative example, the updating can be carried out by adding the value of the status data (optionally after weighting) with the current value of the status parameter of the vehicle.

The updated vehicle status parameter is stored in a database, for example the database 138, during a step 210.

Steps 206-210 are repeated each time the reporting step 204 is carried out. The reporting step 204 can, for example, be mandatory each time a user or an operator wishes to use a vehicle (and/or terminate the use of the vehicle), the use of the vehicle (and/or the termination of the use of the vehicle) being allowed only if the reporting step has been successfully carried out.

The method 200 also comprises a phase 212, called work phase, carried out:
at a predetermined frequency; and/or
after each reporting phase; and/or
each time a vehicle is returned to, or collected from, a site.

This phase 212 comprises a step 214 for determining/updating the value of a status parameter, called site status parameter, associated with each site as a function of:
the vehicle status parameter(s) associated with each vehicle located at said site; and
a predetermined relationship.
   The predetermined relationship can for example be an addition relationship such that determining (updating) the value of the status parameter of the site can be carried out by adding the values of the vehicle status parameters associated with the vehicles present at said site.

During a step 216, at least one site is selected from among all the sites as a function of:
the site status parameter associated with each site; and
a predetermined relationship.
   The predetermined relationship can be a relationship selecting the site having the maximum value of the site status parameter, or all the sites for which the value of the site status parameter is greater than or equal to a predetermined threshold value, and optionally adjustable, etc.

Alternatively, it is possible to select and display a group of “n” sites, for example n=10, that are the most degraded, as described above.

According to yet another alternative, it is also possible to determine the most degraded geographical area, having a predetermined size, and to select some or all of the sites located in said geographical area, as described above.

During a step 218, a maintenance operation is triggered on the selected site(s) by sending identification data to an operator:
of the selected site; and
of the vehicle(s) requiring maintenance, i.e. cleaning, at said selected site.

During this step 218, the operator travels to the selected site in order to carry out the maintenance operation on the vehicle(s) in question. Once the maintenance operation has been carried out on a vehicle, the status parameter associated with said vehicle is reinitialized or set to zero.

Alternatively, if the operator notes that the report of a degraded status is incorrect, for at least one vehicle or one component of a vehicle, the maintenance operation is not carried out and the status parameter associated with said vehicle is reinitialized or set to zero.

FIG. 3 is a diagrammatic representation of an example user interface for reporting a status data relating to the cleanliness of a vehicle.

The interface 300 shown in FIG. 3 can be accessed from inside a vehicle, on a terminal placed at a site for the collection/return of a vehicle, for example the terminal 110 of the installation 100 in FIG. 1, or on a user's or operator's portable communication device, for example the device 144 of the installation 100 in FIG. 1.

The user interface 300 comprises a display area 302, displaying a question relating to the cleanliness status of the vehicle and inviting the user or the operator to select a suggestion from the suggestions displayed in a display area 304.

The display area 304 comprises five emoticons 306₁-306₅, that have different colours and different expressions, corresponding to each of the five suggestions “Very Clean”, “Clean”, “Acceptable”, “Dirty” and “Very Dirty”.

The user can select one of the five suggestions displayed, for example by touch selection on a touch-operated display screen displaying said graphical user interface 300.

Of course, the invention is not limited to the examples which have just been described.

The maintenance can relate to a task other than cleaning the vehicle, such as a repair or a replacement of a component of the vehicle.

In addition, several vehicle status parameters can be associated with each vehicle, each relating to maintenance of the vehicle or an individual component of the vehicle. In this case, the method according to the invention can be implemented independently for each vehicle status parameter.

Alternatively, a single vehicle status parameter can be associated with each vehicle, said single vehicle status parameter being determined as a function of status data relating to several components of the vehicle, or the cleanliness of the vehicle and at least one component of the vehicle. In this case, a weighting can be applied to at least one status data as a function of the component to which said status data relates.

1. A method for the maintenance of vehicles offered for shared use over a plurality of sites, in particular within the framework of an installation for the automated rental of electric vehicles over a plurality of sites, said method comprising for each vehicle, at least one iteration of a phase, called reporting phase, comprising the following steps:
reporting at least one data, called status data, relating to a status of said vehicle or a component of said vehicle;
determining, as a function of said at least one status data, at least one parameter, called vehicle status parameter, associated with said vehicle or said component of said vehicle;
said method also comprising at least one iteration of a phase, called work phase, comprising the following steps:
selecting at least one site, as a function of the vehicle status parameters at least of the vehicles present on said at least one site; and
carrying out a maintenance operation on at least one vehicle at said selected site.

2. The method according to claim 1, characterized in that the selection step comprises selecting, from among all the sites, the site having the largest number of vehicles for which the vehicle status parameter verifies a predetermined relationship, in particular shows a degraded status beyond a predetermined status.

3. The method according to claim 1, characterized in that the selection step comprises selecting, from among all the sites, the site having the vehicle for which the vehicle status parameter shows a status that is the most degraded among all the sites.

4. The method according to claim 1, characterized in that the work phase also comprises a step of determining, for each site, a parameter, called site status parameter, by a predetermined relationship taking account of the status parameter(s) of the vehicle(s) present at said site, the step of selecting a site being carried out as a function of said status parameter of the site.

5. The method according to claim 4, characterized in that the selection step comprises selecting, from among all the sites, at least one site for which the site status parameter verifies a predetermined relationship, in particular shows a degraded status beyond a predetermined status.

6. The method according to claim 4, characterized in that the selection step comprises selecting, from among all the sites, the site for which the site status parameter shows a status that is the most degraded among all the sites.

7. The method according to claim 1, characterized in that the selection step comprises selecting, from among all the sites, a predetermined number of sites for which the statuses are the most degraded, or for which the statuses are degraded beyond a predetermined threshold, as a function of:
the vehicle status parameters of the vehicles located at each of said sites; or
the site status parameters of each of said sites;
said method also comprising displaying on a geographical map the location of said selected sites, as a function of geolocation data of each site.

8. The method according to claim 1, characterized in that the work phase comprises, before the selection step, a step of determining a geographical area, called the most degraded, of a predetermined size, optionally adjustable, comprising the sites the statuses of which are the most degraded, or the statuses of which are degraded beyond a predetermined threshold, as a function of:
the vehicle status parameters of the vehicles located at each of said sites; or
the site status parameters of each of said sites;
the selection step comprising a selection of one or more, in particular all, the sites located in said geographical area.

9. The method according to claim 1, characterized in that it comprises, for at least one vehicle, a step of reinitialization of the status parameter of said vehicle following sending, by an operator, of a data reporting:
the end of a maintenance operation on said vehicle; or
a statement, by the operator, of a non-degraded status of said vehicle or a component of said vehicle.

10. The method according to claim 1, characterized in that for at least one vehicle, at least one reporting step is carried out from inside said vehicle or at said vehicle, by a user of said vehicle or by an operator working on said vehicle.

11. The method according to claim 1, characterized in that for at least one vehicle, at least one reporting step is carried out through a user interface in said vehicle.

12. The method according to claim 1, characterized in that, for at least one vehicle, at least one reporting step is carried out through a user interface on:
a terminal located at a site at which said vehicle is located; or
a portable communication device.

13. The method according to claim 1, characterized in that, for at least one vehicle, a step of weighting at least one status data by at least one weighting coefficient the value of which is a function of:
the originator of the report of said status data;
a value of said status data;
a duration separating the report of said status data from a previous report;
said vehicle status parameter being determined as a function of said weighted status data.

14. The method according to claim 1, characterized in that the reporting step realizes the reporting of a status data relating to a general cleanliness status of the vehicle, the vehicle status parameter showing said cleanliness status, and the maintenance operation carried out comprises a vehicle cleaning operation.

15. The method according to claim 1, characterized in that a vehicle is associated with several vehicle status parameters, each relating to a component of said vehicle:
the reporting step comprising a reporting of a status data relating to one or more components of the vehicle; and
the working phase being carried out independently for each vehicle status parameter.

16. The method according to claim 1, characterized in that a single vehicle status parameter is associated with a vehicle, determined as a function of status data relating to several components of the vehicle, the reporting step comprising reporting a status data relating to one or more components of the vehicle.

17. The method according to claim 16, characterized in that it comprises a weighting of at least one status data, as a function of the nature of the component to which said status data relates, the single vehicle status parameter being determined as a function of said weighted status data.

18. The A system for the maintenance of vehicles offered for shared use over a plurality of sites, in particular within the framework of an installation for the automated rental of electric vehicles over a plurality of sites, said system comprising means configured in order to implement all the steps of the method according to claim 1.

19. The system according to claim 18, characterized in that it comprises:
at least one interface for reporting a status data from inside each vehicle or from each site or through a portable communication device, configured in order to send to a remote server, through a communications network, a data relating to a status of the vehicle or a functional status of a component of the vehicle;
at least one server, placed at a central site, and configured in order to:
receive status data for at least one, in particular each, vehicle;
determine at least one parameter, called vehicle status parameter, associated with each vehicle;
select at least one site from the plurality of sites as a function of said at least one vehicle status parameter; and
trigger a maintenance operation on at least one vehicle at said at least one selected site.

20. An installation for the automated rental of vehicles, in particular electric vehicles, over a plurality of sites, said installation comprising:
a system according to claim 18; or
means configured for implementing all the steps of the method according to a method for the maintenance of vehicles offered for shared use over a plurality of sites, in particular within the framework of an installation for the automated rental of electric vehicles over a plurality of sites, said method comprising for each vehicle, at least one iteration of a phase, called reporting phase, comprising the following steps:
reporting at least one data, called status data, relating to a status of said vehicle or a component of said vehicle;
determining, as a function of said at least one status data, at least one parameter, called vehicle status parameter, associated with said vehicle or said component of said vehicle;
said method also comprising at least one iteration of a phase, called work phase, comprising the following steps:
selecting at least one site, as a function of the vehicle status parameters at least of the vehicles present on said at least one site; and
carrying out a maintenance operation on at least one vehicle at said selected site.
